(19) United States
(12) Patent Application Publication
(10) Pub. No.: US 2004/0065753 A1
(43) Pub. Date: Apr. 8, 2004

(54) Sprinkler spacer

(76) Inventor: J. Craig Corbett, Lyman, WY (US)

Correspondence Address: Dean P. Edmundson, P.O. Box 179, Burton, TX, 77835, US

(21) Appl. No.: 10/674,222

(22) Filed: Sep. 29, 2003

Related U.S. Application Data
(60) Provisional application No. 60/416,086, filed on Oct. 5, 2002.

(51) Int. Cl. B05B 15/06

(52) U.S. Cl. 239/273; 239/200; 239/201; 239/288

(57) ABSTRACT

Sprinkler head spacer systems for preventing a sprinkler head from being positioned too close to a sidewalk or curb. The spacers include a body and attachment fingers for attachment of the spacers to a sprinkler. Various styles are disclosed, including some in which the fingers are detachable from the body. In other versions the spacing between the fingers is adjustable to accommodate sprinklers of different diameters.

### CROSS-REFERENCE TO RELATED APPLICATIONS

This application is related to my application Ser. No. 10/007,712, filed Nov. 13, 2001, now U.S. Pat. No. 6,575,380, issued Jun. 10, 2003. This application is also related to my pending application Ser. No. 10/626,910, filed Jul. 25, 2003. This application is also related to, and claims the benefit of, my Provisional Application No. 60/416,086, filed Oct. 5, 2002.

### FIELD OF THE INVENTION

This invention relates to sprinkler systems commonly used for sprinkling lawns or other landscaped areas. More particularly, it relates to installation techniques for sprinkler systems and to spacer guides for positioning sprinkler heads.

### BACKGROUND OF THE PRIOR ART

Typical sprinkler systems used for lawns and other landscaped areas include water supply lines which are placed below ground and extend from a main supply pipe to each sprinkler head. The sprinkler head extends upwardly to the upper surface of the ground. Typical sprinkler heads are of the “pop-up” style which extend upwardly above the grass when pressure is applied to the water in the supply line, and then the sprinkler head retracts when it is no longer in use. The top of the sprinkler head remains exposed at ground level.

In some installations, the sprinkler head is connected to the water supply pipe with a flexible pipe. Although this enables the installer to more easily position the sprinkler head in a desired place, the flexible pipe provides little, if any, support to the sprinkler head (either lateral or vertical support). As a result, when soil is filled in around the sprinkler head, the sprinkler head can tilt to one side or the other, and the sprinkler head can also sink downwardly. When the sprinkler head is too close to a sidewalk, curb or other such object, the spinning metal blade of an edger can irreparably damage any sprinkler head which is too close to sidewalk, curb, etc. Then the sprinkler head must be replaced, at considerable time and expense.

U.S. Pat. No. 4,146,181 (Soos), U.S. Pat. No. 5,678,353 (Tsao et al), U.S. Pat. No. 6,186,416 (Jones), and D410,731 (Bowman et al.) describe various types of sprinkler head guards, grass guards and mats for use on or around sprinkler heads. However, there has not heretofore been provided a sprinkler spacer of the types described in the present invention.

### SUMMARY OF THE INVENTION

In accordance with the present invention there are provided improved sprinkler head spacers for supporting sprinkler heads in lawns or other landscaped areas. When the spacers are attached to sprinkler heads (e.g. during installation in the ground), the spacers prevent sprinkler heads from being positioned too close to a sidewalk, curb, etc. The spacers can be attached to sprinkler heads in a number of different manners, and the spacers are adapted to fit onto sprinkler heads of different diameters.

In one embodiment, the sprinkler spacer comprises:

(a) a spacer body member having first and second lateral edges;

(b) attachment means carried by said body member for attaching said body member to said sprinkler;

wherein the attachment means is detachably mounted to the body member.

The attachment means can comprise a pair of opposing spring clips, for example, which can be attached to the spacer body (e.g. by means of raised ribs or tabs on the spring clips which fit into complementary slots in the spacer body).

In another embodiment, the spacer system comprises two body members which are hinged together. Each body member includes a spring finger portion. The body members are further connected by a length-adjustable rod which controls the spacing between the respective finger portions of the two body members.

Other features and advantages of the spacer system of this invention will be apparent from the following detailed description and the accompanying drawings.

### BRIEF DESCRIPTION OF THE DRAWINGS

FIG. 1 is a plan view of one embodiment of spacer system of the invention;

FIG. 2 is a plan view of another embodiment of a spacer system of the invention;

FIG. 3A is a plan view of another embodiment of a spacer body portion;

FIG. 3B is a front elevational view of an attachment member adapted to connect to the spacer body portion of FIG. 3A;

FIG. 4 is a side elevational view of the spacer system of FIG. 1;

FIG. 5 is a plan view of yet another embodiment of a spacer system of the invention;

FIG. 6 is a plan view of a further embodiment of a spacer system of the invention;

FIG. 7 is a perspective view showing a spacer body attached to a sprinkler;

FIG. 8 is a perspective view showing a depth gauge which can be attached to a spacer body; and

FIG. 9 is a perspective view showing the depth gauge of FIG. 8 attached to the spacer body of FIG. 7, prior to the spacer body being attached to a sprinkler.

### DETAILED DESCRIPTION OF THE INVENTION

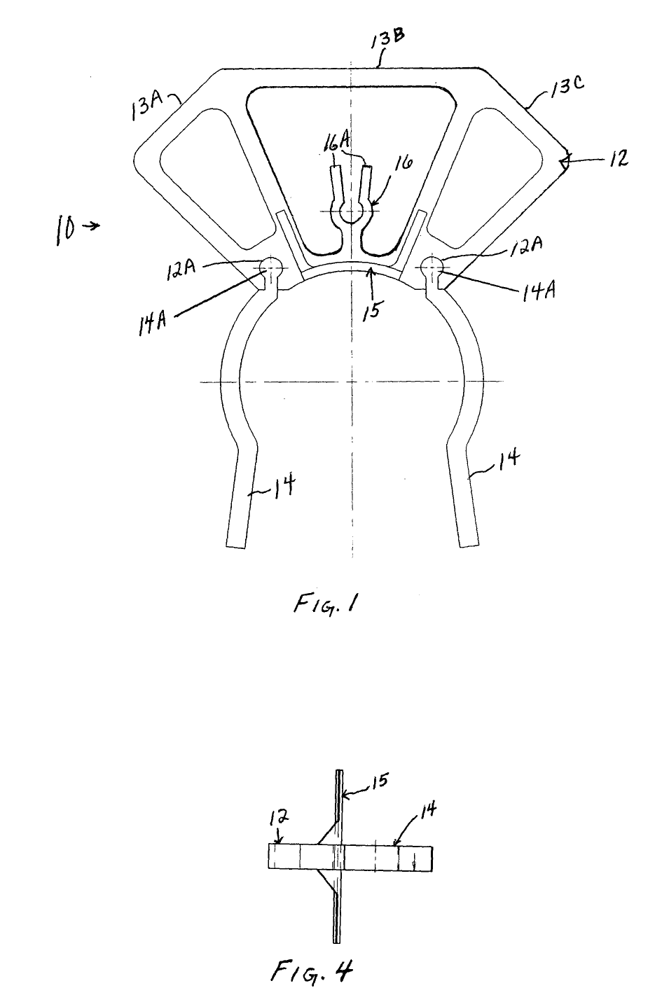

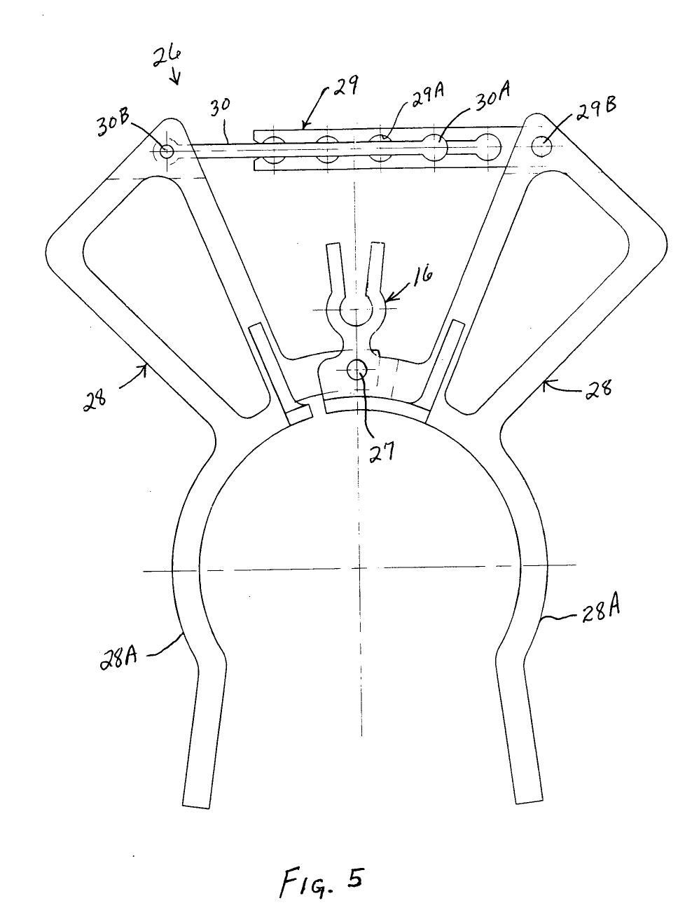

In FIGS. 1 and 4 there is shown one embodiment of a spacer system 10 of the invention comprising a spacer body portion 12 and a pair of opposing spring finger clip members 14. Each spring clip finger includes an enlarged end 14A which is slidably received and retained in a complementary shaped slot 12A in body portion 12. This design enables the spacer body to be used with different sizes of spring finger clips. For example, when using large diameter sprinklers, appropriately sized spring finger clips can be attached to the spacer body to accommodate the large sprinkler body. Conversely, if a small diameter sprinkler is used, then smaller spring finger clips can be used on the spacer body.

Preferably the body portion comprises spaced-apart ribs with vertical openings between them, as shown in the drawings, to enable water and fertilizer, etc. to pass through the spacer after installation. The body portion 12 preferably includes edges 13A, 13B and 13C which are at angles to each other (e.g. edges 13A and 13C may be at 45 degrees relative to edge 13B). The presence of these angled edges enables the spacer to be positioned next to sidewalks, curbs, etc. to maintain a predetermined spacing between the sprinkler head and the concrete material. The presence of these angled edges also enable the spacer to be positioned in a corner (e.g. where two sidewalks meet, or where a sidewalk meets a curb) so that one such edge abuts against the edge of one sidewalk and the other such edge abuts against the edge of another sidewalk (or curb), regardless of the particular angle between the two sidewalks or sidewalk and curb, etc.

Preferably the spacer body also has attached to it one or more vertical tabs 15 having a length of about 1.5 inches. The presence of the tab(s) is to assure that the spacer body is properly positioned about 1.5 inches below the upper end of the sprinkler body. This arrangement assures that the spacer body will not be impacted by the blade of a metal edger used along a sidewalk, curb, etc. There may be a vertical tab 15 extending upwardly from the upper surface of the spacer and another vertical tab extending downwardly from the lower surface of the spacer. The presence of two such tabs makes the spacer symmetrical (so that it cannot be clipped or attached to a sprinkler upside down). Whichever way the spacer is attached to a sprinkler, one of the vertical tabs will be oriented upwardly. If desired, the tab (depth gauge) may be separate from the spacer body so that the depth gauge is vertically adjustable. This enables the spacer to be positioned lower or higher relative to the sprinkler, as desired.

Preferably, the spacer body also includes a stake receiver 16 having resilient legs or arms 16A. In order to provide additional lateral stability to a sprinkler head, a vertical stake can be inserted vertically through the receiver 16 (between arms 16A) and into the ground when the sprinkler is installed. The length and design of such a stake may vary. Once installed, the spacer and stake assembly holds the sprinkler in place so that the complete irrigation system can be turned on for a pressure test before the sprinkler trenches have been filled. This enables the sprinklers and pipes to be checked for leaks, adjustment, etc. The spray coverage can also be checked to assure there are no dry areas. Necessary adjustments or replacement of sprinklers can be made as required. This a huge advantage and saves a tremendous amount of time because any leaks or other problems with the irrigation system can be corrected before the trenches are filled. The stakes and spacers hold and support the sprinklers in their intended position so that the irrigation system can be fully tested.

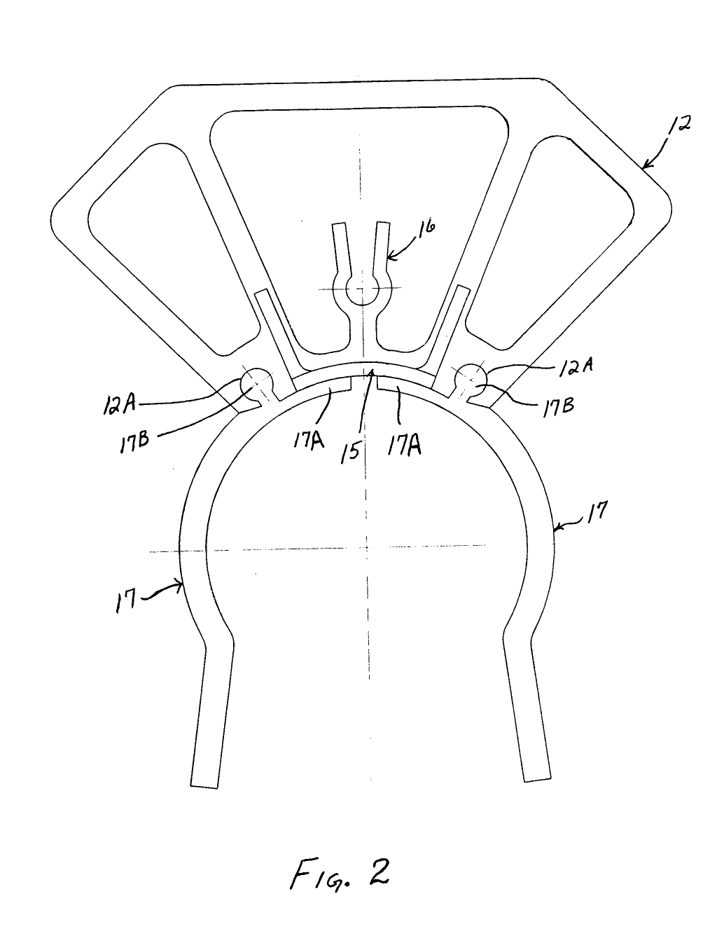

In FIG. 2 there is shown another spacer system utilizing the same spacer body 12 but different types of opposing spring finger clips 17. As shown, these spring fingers each include an enlarged rib 17B for sliding engagement in a slot 12A in the spacer body 12. Each spring finger also includes an inner end 17A which extends past the point where the rib 17A is located in order to provide additional support and rigidity to the spring finger clip mounting.

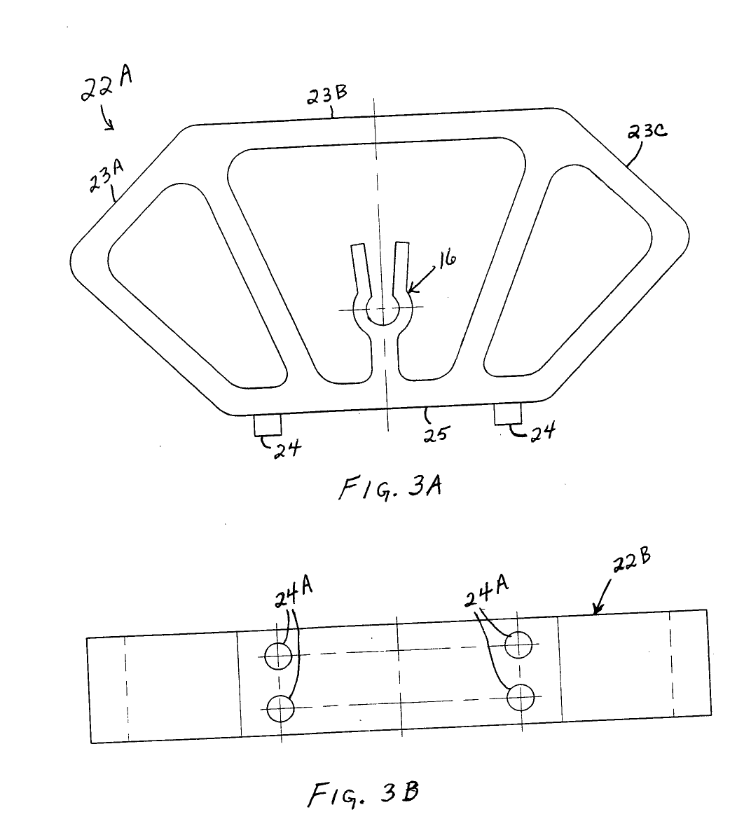

In FIGS. 3A and 3B there is shown another spacer system comprising a spacer body 22A (top plan view) having an inner lateral edge 25 and outer edges 23A, 23B and 23C. On edge 25 there are provided a plurality of spaced-apart, projecting tab members 24. On spring clip finger portion 22B (rear elevational view) there are a corresponding plurality of recessed openings or sockets 24A which are adapted to slidably receive the tab members 24 and thereby hold the spring clip finger portion to the spacer body.

In FIG. 5 there is shown another embodiment of spacer system 26 comprising complementary shaped body portions 28 which are hinged together intermediate their ends with pin 27. Each body portion includes a spring clip finger 28A. At the opposite end of the spacer there is a length-adjustable connector. Elongated receiver connector 29 is fastened to one body portion 28 by means of pin 29B. The connector 29 includes a plurality of longitudinally spaced-apart recessed areas or sockets 29A. Elongated connector rod 30 is fastened to the other body member 28 by means of pin 30B. The opposite end of connector rod 30 includes an enlarged end 30A which is adapted to be received in a desired one of the recessed areas or sockets 29A. Depending upon which of the sockets 29A the enlarged end 30A is received in, the spacing between the spring finger clips 28A will be different so as to accommodate sprinkler heads of different diameters. As shown, this spacer system may also include a stake receiver 16 of the type described above which enables an elongated stake to be inserted into, and held by, the receiver 16. Then the stake will extend downwardly from the spacer to provide lateral and vertical support to the sprinkler held by the fingers 28A.

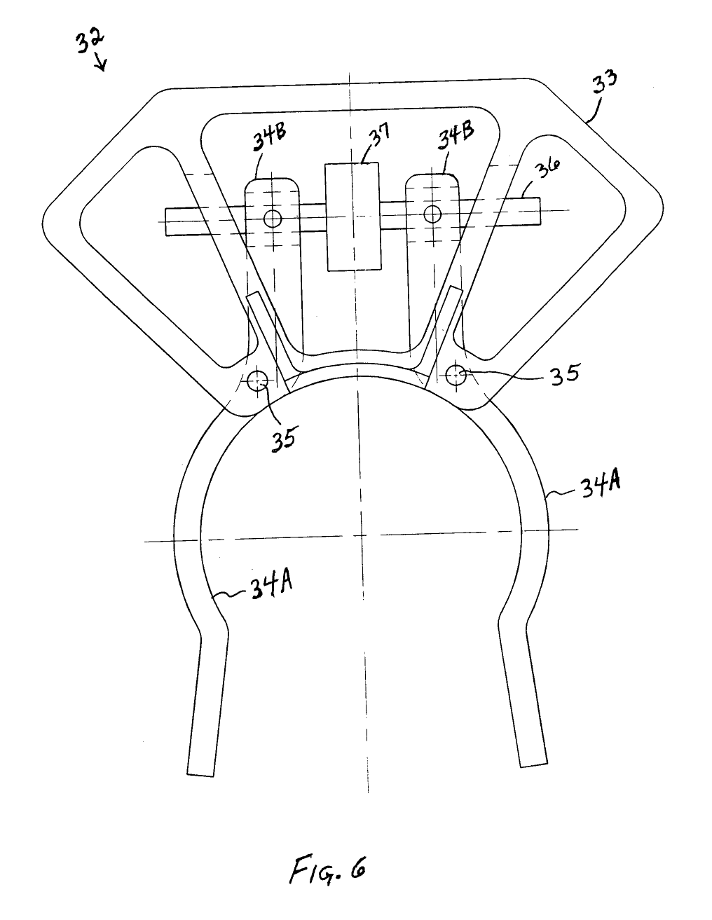

In FIG. 6 there is shown another spacer system 32 of the invention comprising spacer body member 33 and a pair of spring clip fingers 34A. The fingers 34A are each pivotably attached to the body portion 33 by means of pins 35. At the inner end 34B of each finger there is secured a threaded receiver which is connected to threaded rod 36. A centrally located rotating knob 37 on rod 36 enables the rod 36 to be easily rotated so as to cause the respective fingers 34A to be moved selectively closer together or further apart in order to accommodate sprinkler heads of different diameters.

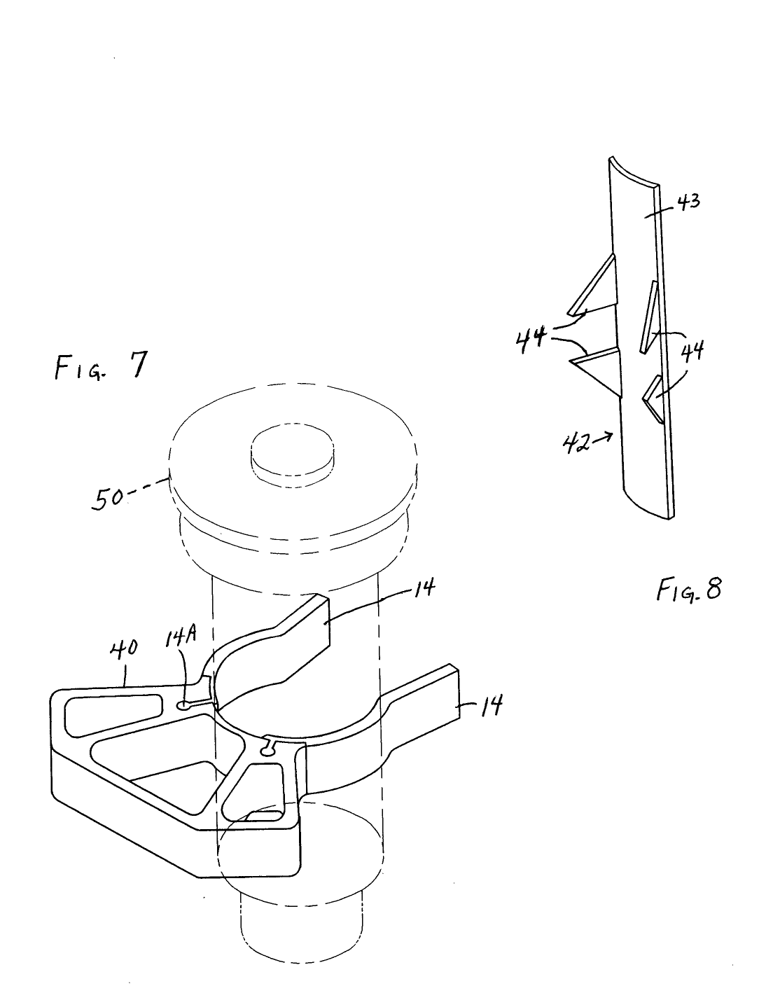

FIG. 7 is a perspective view showing a spacer body 40 of the invention with spring finger clip members 14 attached to one edge of the spacer body. Each spring clip finger includes an enlarged end 14A which is slidably received and retained in a complementary shaped slot in the body 40, as shown. The spring clip fingers are adapted to attach the spacer body to a sprinkler 50, as illustrated.

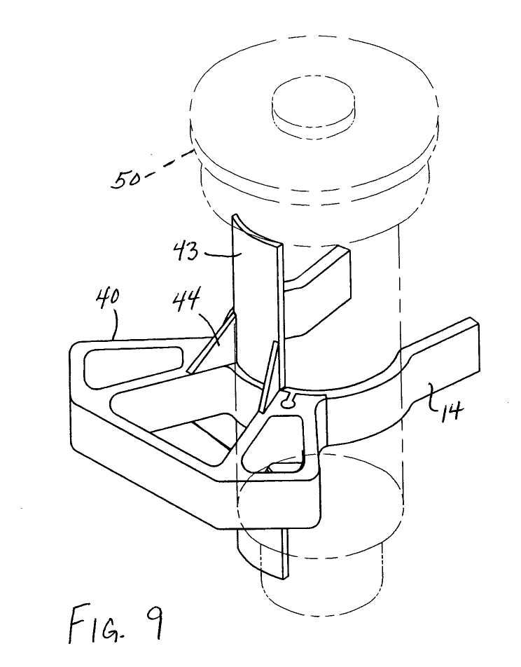

FIG. 8 is a perspective view of a depth gauge 42 comprising an elongated strip 43 having two spaced-apart tabs 44 extending outwardly from each side of the strip, as shown. The spacing between each set of two tabs is only slightly greater than the thickness of spacer body 40 such that the spacer body can be slidably received between the tabs and held there with frictional engagement. This is illustrated in FIG. 9 where the depth gauge is attached to spacer body 40 and then spacer body 40 is attached to the sprinkler. The depth gauge prevents the spacer body from sliding too far upwardly on the sprinkler (i.e. the depth gauge assures that the spacer body will be positioned a minimum distance below the top of the sprinkler head). Typically, the depth gauge can be composed of plastic and produced by injection molding techniques. Preferably the tab members 44 are disposed in the center of the depth gauge, as shown, so that the gauge is symmetrical and can be attached to the spacer body with either end of the depth gauge extending upwardly. Of course, it would be possible to position the tabs closer to one end of the gauge, if desired, so as to have a smaller distance between the tabs and one end of the strip.

Other variants are possible without departing from the scope of this invention.

What is claimed is:

1. A sprinkler head spacer system useful for attachment to the body of a water sprinkler to prevent the positioning of the sprinkler too close to a sidewalk or curb, the spacer system comprising:
(a) a body member having first and second lateral edges;
(b) attachment means carried by said body member for attaching said body member to said sprinkler;
wherein said attachment means is detachably mounted to said body member.

2. The system in accordance with claim 1, wherein said first lateral edge of said body member includes spaced-apart first and second slots; wherein said attachment means comprises first and second spring clip members each having a raised rib; wherein said raised ribs of said spring clip members are slidably received in said first and second slots, respectively, to fasten said spring clip members to said body member.

3. The system in accordance with claim 1, wherein said body member includes openings extending therethrough.

4. The system in accordance with claim 1, wherein said first lateral edge of said body member includes spaced-apart first and second slots; wherein said attachment means comprises a spring clip member having opposing fingers and further comprises tab members which are slidably received in said first and second slots to fasten said spring clip members to said body member.

5. The system in accordance with claim 1, wherein said first lateral edge of said body member includes a plurality of recessed sockets; wherein said attachment means comprises a plurality of outwardly projecting tab members which are sized and spaced such that they are slidably received in said recessed sockets of said body member to fasten said attachment means to said body member.

6. The system in accordance with claim 1, further comprising a depth gauge which is detachably secured to said body member.

7. The system in accordance with claim 6, wherein said depth gauge comprises an elongated strip having spaced-apart tabs extending outwardly therefrom for engaging said body member.

8. A sprinkler head spacer system useful for attachment to the body of a water sprinkler to prevent the positioning of the sprinkler too close to a sidewalk or curb, the spacer system comprising first and second body members which are hinged together; wherein each said body member includes a spring finger portion and a spacer portion; wherein said spacer system further comprises a length-adjustable connector extending between, and being attached to, said spacer portions of said first and second body members.

9. The system in accordance with claim 8, wherein said length-adjustable connector comprises:
(a) an elongated member connected at one end to said first body member; wherein said elongated member includes a plurality of longitudinally spaced sockets; and
(b) an elongated rod member having first and second ends; wherein said first end is connected to said second body member; wherein said second end of said rod member includes an enlarged tab member which is sized to fit into a selected one of said sockets.

10. A sprinkler head spacer system useful for attachment to the body of a water sprinkler to prevent the positioning of the sprinkler too close to a sidewalk or curb, the spacer system comprising:
(a) a body member having first and second lateral edges;
(b) attachment means comprising first and second opposing spring fingers pivotably connected to said body member for attaching said body member to said sprinkler; and
(c) a threaded member connected between said opposing spring fingers and being adapted to adjust the spacing between said spring fingers.
